(19) United States
(12) Patent Application Publication
(10) Pub. No.: US 2016/0069515 A1
(43) Pub. Date: Mar. 10, 2016

(54) EMERGENCY DISPOSAL OF STORAGE CONTAINERS

(71) Applicant: LINDE AKTIENGESELLSCHAFT, München (DE)

(72) Inventor: Thomas Knoche, GaiBach (DE)

(21) Appl. No.: 14/785,935

(22) PCT Filed: May 6, 2014
(86) PCT No.: PCT/EP2014/001205

§ 371 Date: Oct. 21, 2015

(30) Foreign Application Priority Data
May 14, 2013 (DE) 102013008215.3

(51) Int. Cl. F17C 13/04; F16K 15/18; F17C 13/12

(52) U.S. Cl. CPC F17C 13/04; F17C 13/12; F16K 15/18; F17C 2205/0332; F17C 2221/012; F17C 2221/033; F17C 2260/042; F17C 2250/0626

(57) ABSTRACT

A device for the emergency evacuation of a storage tank, in particular a storage tank used to store combustible media, such as hydrogen. The storage tank is connected with a chimney by way of a relief line, and the relief line exhibits at least one pneumatically actuated relief valve, wherein the latter is pneumatically held in the closed position and opened by a spring force while relieving the pneumatic control line, or held in the closed position by a spring force and pneumatically opened.

The invention relates to a device for the emergency evacuation of a storage tank, in particular a storage tank used to store combustible media, such as hydrogen, oxygen and natural gas.

The problem in storage tanks used to store explosive or combustible media is that they can burst in response to outside influences or dangers, for example external firing or spontaneous firing due to ignited leaks (jet flames), which can result in major damage.

Hydrogen and other combustible gases are in part stored under very high pressures (up to 1000 bar), so that they can be dispensed, as an energy carrier. The storage tanks used for this purpose consist in part of composite materials, which react comparatively sensitively to external forces, in particular to high temperatures.

In case of danger, it often makes sense or becomes necessary to evacuate the storage tank to minimize the consequences of a potential tank failure. However, this emergency evacuation also presents dangers. For example, the explosive gas clouds formed by the release can spontaneously or belatedly ignite, which can result in explosions and strong thermal radiation. Therefore, it is absolutely essential that a faulty activation of the emergency evacuation or emergency stress relief be avoided. By contrast, the emergency stress release function must be highly reliable or available in case of danger.

At present, storage tanks for combustible gases often do not offer the capability of remote quick stress relief from a sate location. In case of danger, the relief forces and operating staff have no way of performing an emergency evacuation of the at-risk tank so as to reduce and avoid consequential damages. One often mentioned argument against such devices involves an inadvertent release of the tank content during malfunctions, which can be caused by an instrument air supply failure, for example.

Primarily thermally actuated safety valves are currently in use. However, the latter are only actuated given a distinct rise in their ambient temperature. In specific danger situations, e.g., open-air hydrogen flames, which only exhibit a slight thermal radiation, there is no adequate temperature rise, so that these safety valves are not actuated.

The object of the present invention is to indicate a generic device for the emergency evacuation of a storage tank, in particular a storage tank used to store combustible media, e.g., hydrogen, which enables a reliable, remote-controlled emergency evacuation of a storage tank.

It is proposed that this object be achieved with a device for the emergency evacuation of a storage tank that is characterized by the fact that the storage tank is connected with a chimney by way of a stress relief line, and the stress relief line exhibits at least one pneumatically actuated relief valve, wherein the latter is either pneumatically held in the closed position and opened by a spring force while relieving the pneumatic control line, or held in the closed position by a spring force and pneumatically opened.

Given a necessary or desired emergency evacuation of a storage tank, the medium to be removed from the storage tank is fed to a chimney via the relief line as described in the invention after opening the pneumatically actuated relief valve(s). The combustible medium is guided to a safe location via the latter and released into the atmosphere.

In a further development of the device for the emergency evacuation of a storage tank according to the invention, it is proposed that the pneumatic control line of the relief valve have an autonomous control gas supply. This decoupling from the operational control gas supply can ensure a high availability. In addition, this embodiment serves as protection against faulty activation.

The relief line advantageously exhibits at least two pneumatically actuated relief valves, wherein the latter are interconnected in such a way that the relief line is only opened after all relief valves have been actuated. This embodiment of the device according to the invention for the emergency evacuation of a storage tank reduces the risk of an inadvertent faulty operation of the emergency evacuation procedure.

Another advantageous embodiment of the device according to the invention for the emergency evacuation of a storage tank is characterized in that the evacuation line exhibits a throttle, which makes it possible to limit the quantity of medium flowing out through the relief line. As a result of this embodiment, a quick evacuation can be realized while at the same time limiting the quantity relieved.

The means, e.g., hand valves, for relieving the pneumatic control line are advantageously situated at a location lying outside of the potential dancer zone of the storage tank. This allows the relief forces and operating staff to safely activate the emergency evacuation procedure by remote control. Alternatively or additionally, the means for relieving the pneumatic control fine given a relief valve opened by a spring force are designed as a control line consisting of a material that is not fire or temperature resistant, e.g., a plastic material. In case of a fire or elevated temperature, this automatically triggers the emergency evacuation process.

The device according to the invention for the emergency evacuation of a storage tank enables a reliable, safe and quick evacuation of a storage tank in case of danger, wherein inadvertent faulty operations can be precluded.

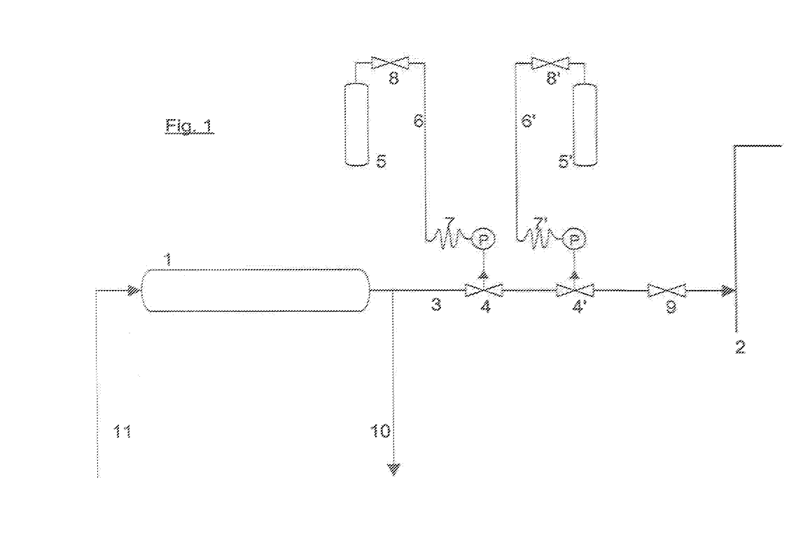

The device according to the invention for the emergency evacuation of a storage tank will be described in greater detail below based on the exemplary embodiment illustrated on FIG. 1. The exemplary embodiment presents a variant of the device according to the invention, in which the relief line exhibits two pneumatically activated relief valves.

The storage tank 1 suitable in particular for storing combustible media, e.g., hydrogen, exhibits a relief line 10 along with a fill and retain line 11; the latter are used to remove the medium stored therein or again supply it to the storage tank 1.

The storage tank 1 is connected with a chimney 2 by way of a relief line 3. Provided in the relief line 3 are two pneumatically activated relief valves 4 and 4′, which are pneumatically held in the closed position. The two storage tanks 5 and 5′ that serve to store the control medium, e.g., instrument air, are used for this purpose. The latter are connected with the relief valve 4 or 4′ by way of the line 6 or 6′ and the pneumatic control line 7 or 7′. In addition, a throttle 9 is provided in the relief line 3. The latter makes it possible to limit the quantity of medium flowing out of the storage tank 1 by way of the relief line 3.

The relief valves 4 and 4′ are advantageously interconnected in such a way that the relief line 3 is only opened after both relief valves have been actuated. This embodiment of the device according to the invention reduces the risk of an inadvertent faulty operation of the emergency evacuation procedure.

In the embodiment shown on FIG. 1, the means for relieving the pneumatic control line 7 and 7′ are designed as valves 8 and 8′, hand valves. They must be situated in a location lying outside the potential danger zone of the storage tank 1. This allows the relief forces and operating staff to safely activate the emergency evacuation procedure by remote control. In addition, the pneumatic control line 7 and 7′ can consists of a material that is not fire or temperature resistant, e.g., a plastic material. In case of a fire or elevated temperature, the emergency evacuation process is thus automatically triggered if the pneumatic control line 7 and 7′ is damaged or destroyed.

1. An arrangement for the emergency evacuation of a storage container, characterized in that the storage container is connected with a chimney by a decompression line, and the decompression line comprises at least one pneumatically actuated relief valve, wherein the at least one pneumatically actuated relief valve is either pneumatically kept in the closed position and opened by a spring force when the pneumatic control line is relieved, or is kept in the closed position by a spring force and pneumatically opened, and the means for relieving the pneumatic control line are situated at a location lying outside the potential danger zone of the storage container.

2. The arrangement according to claim 1, characterized in that the decompression line exhibits at least two pneumatically actuated relief valves, wherein the at least two pneumatically actuated relief valves are interconnected in such a way that the decompression line is only opened once all of the relief valves have been actuated.

3. The arrangement according to claim 1, characterized in that the pneumatic control line of the relief valve has an autonomous control gas supply.

4. The arrangement according to claim 1, characterized in that the decompression line comprises a throttle, which makes it possible to limit the quantity of the medium being discharged via the decompression line.

5. The arrangement according to claim 1, characterized in that the means for relieving the pneumatic control line in a relief valve opened by a spring force are designed as a control line made out of a non-fire- or temperature-resistant material.

8. The arrangement according to claim 1, characterized in that the storage container is used to store flammable media.

7. The arrangement according to claim 6, characterized in that the flammable media is hydrogen.
